(19) United States
(12) Patent Application Publication
(10) Pub. No.: US 2013/0189653 A1
(43) Pub. Date: Jul. 25, 2013

(54) SET OF BLOCKS WITH BEGINNING, MIDDLE AND ENDING BLOCKS HAVING CONNECTORS AND ALPHABETICAL INDICIA

(71) Applicants: Robin Duncan Milne, Huntington Beach, CA (US); Anna Kirschberg, Huntington Beach, CA (US)

(72) Inventors: Robin Duncan Milne, Huntington Beach, CA (US); Anna Kirschberg, Huntington Beach, CA (US)

(21) Appl. No.: 13/356,339

(22) Filed: Jan. 23, 2012

(51) Int. Cl. G09B 1/00

(52) U.S. Cl. 434/159

(57) ABSTRACT

There is provided a set of blocks including a plurality of beginning, middle and ending blocks. The blocks each have an indicia face with alphabetical indicia, a front end and a rear end. The middle block front end includes a first connector having a first gender type. The rear end includes a second connector having a first gender type. The beginning block rear end includes a beginning block primary connector having a second gender type. The beginning block primary connector is engageable with a first connector. The beginning block primary connector is not engageable with a second connector. The ending block front end includes an ending block primary connector having a second gender type. The ending block primary connector is engageable with a second connector. The ending block primary connector is not being engageable with a first connector.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure generally relates to an educational toy blocks, and more particularly, to a set of toy blocks with alphabetical indicia appearing on the blocks.

2. Related Art

There are a number of apparatus available for teaching alphabet, reading and spelling concepts with the use of toy blocks with alphabetical indicia appear on one or more faces of the blocks. The blocks are manipulated into linear groupings to form words, syllables, sentences and the like.

For example, U.S. Pat. No. 6,685,477 discloses a set of universally connectable six sided blocks that include reading or alphabetical indicia on multiple faces. These blocks are configured to be removeably attachable to each other. Each block includes a face that includes a female portion and an opposing face that includes a male portion. The male portion of a given block is configured to engage a female portion of any other block to attach the corresponding blocks. The alphabetical indicia are pre-applied to the blocks so that the alphabetical indicia are readable with the male portion oriented to the user's right to facilitate left-to-right reading practice of the English language.

Another example is U.S. Pat. No. 5,554,062 that describes set of toy educational six sided blocks. Each block includes five faces that include female connectors and one face that includes a male connector. The male connectors are configured to engage the female connectors for attaching blocks to each other. A plurality of letter units is provided with each taking the form of a flat plate with a male connector. The letter units include alphabetical indicia on the face of the flat plate with the male connector extending from an opposite side of the plate to allow the letter units to be attached to selected ones of the blocks.

The above described prior blocks are universally connectable in that any block may be attached to any other block. While this connection configuration allows for great flexibility in arranging the alphabetical indicia of adjacent blocks with respect to each other, it is necessarily independent of the alphabetical indicia. This allows for the alphabetical indicia of a face of such a prior art block to be attached and positioned with respect to other blocks in any manner. Accordingly, there is a need in the art for an improved set of blocks that guides attachment of the blocks in a manner that facilitates an enhanced teaching or learning.

### BRIEF SUMMARY

According to an aspect of the invention, there is provided a set of blocks including a plurality of beginning, middle and ending blocks. The plurality of middle blocks each have an indicia face, a front end and a rear end disposed opposite the front end with the indicia face disposed between the front and rear ends. The indicia face includes alphabetical indicia. The front end includes a first connector. The first connector has a first gender type. The rear end includes a second connector. The second connector has a first gender type. The plurality of beginning blocks each have an indicia face, a front end and a rear end disposed opposite the front end with the indicia face disposed between the front and rear ends. The indicia face includes alphabetical indicia. The rear end includes a beginning block primary connector. The beginning block primary connector has a second gender type opposite of the first gender type. The beginning block primary connector is engageable with a first connector of a middle block with the indicia faces of the beginning block and the middle block being aligned. The beginning block primary connector is not engageable with a second connector of a middle block. The plurality of ending blocks each has an indicia face, a front end and a rear end disposed opposite the front end with the indicia face disposed between the front and rear ends. The indicia face includes alphabetical indicia. The front end includes an ending block primary connector. The ending block primary connector has a second gender type opposite of the first gender type. The ending block primary connector is engageable with a second connector of a middle block with the indicia faces of the ending block and the middle block being aligned. The ending block primary connector is not engageable with a first connector of a middle block.

The above described connection configuration is contemplated facilitate use of the blocks 10 that permit specific connection between the blocks. This enables particular alphabetical indicia to be placed on selected ones of the pluralities of the beginning, middle and ending blocks in a logical manner to facilitate proper orthographical combinations of the blocks according to their associated alphabetical indicia.

According to various embodiments, the first gender type may be female and the second gender type may be male. The first and second connectors of the middle blocks have differing cross-sectional configurations. The first and second connectors of the middle blocks may have a circular cross section. The beginning blocks, the middle blocks, and the ending blocks may each have a triangular cross-section through the indicia faces. The front end of each beginning block may include a beginning block secondary connector having a second gender type. The rear end of each ending block may include an ending block secondary connector having a second gender type.

The alphabetical indicia of the indicia face of a beginning block may be a consonant or consonant digraph, and the alphabetical indicia of the indicia face of a middle block may be a vowel or vowel digraph. The alphabetical indicia of the indicia faces of the beginning and middle blocks combine to form a syllable.

The alphabetical indicia of the indicia face of an ending block may be a consonant or consonant digraph, and the alphabetical indicia of the indicia face of a middle block may be a vowel or vowel digraph. The alphabetical indicia of the indicia faces of the ending and the middle blocks combine to form a syllable.

The alphabetical indicia of the indicia face of a beginning block may be a consonant or consonant digraph, the alphabetical indicia of the indicia face of a middle block may be a vowel or vowel digraph, and the alphabetical indicia of the indicia face of an ending block may be a consonant or consonant digraph. The alphabetical indicia of the indicia faces of the beginning, the middle and the ending blocks combine to form a syllable.

The alphabetical indicia of the indicia face of a beginning block may be a consonant or consonant digraph, the alphabetical indicia of the indicia face of a middle block may be a vowel, the alphabetical indicia face of an ending block may be a consonant, and the alphabetical indicia of another ending block may be a grapheme ‘e.’ The alphabetical indicia of the indicia faces of the beginning, the middle and the ending blocks combine to form a syllable containing a split digraph.

The alphabetical indicia of the indicia face of a beginning block may be an onset and the alphabetical indicia of the indicia face of a middle block may be a rime with the onset and the rime, the alphabetical indicia of the indicia faces of the beginning and the ending blocks combine to form a word.

The alphabetical indicia of the indicia face of a beginning block may be a prefix and the alphabetical indicia of the indicia face of a middle block may be a root word. The alphabetical indicia of the indicia faces of the beginning and the ending blocks combine to form a word.

The alphabetical indicia of the indicia face of an ending block may be a suffix and the alphabetical indicia of the indicia face of a middle block may be a root word. The alphabetical indicia of the indicia faces of the middle and the ending blocks combine to form a word.

The alphabetical indicia of the indicia face of a beginning block may be a prefix, the alphabetical indicia of the indicia face of a middle block may be a root word, and the alphabetical indicia of the indicia face of an ending block may be a suffix with the prefix. The alphabetical indicia of the indicia faces of the beginning, the middle and the ending blocks combine to form a word.

The set of blocks may further include a plurality of spacer blocks. Each of the spacer blocks has a blank face, a front end and a rear end disposed opposite the front end. The blank face does not include any alphabetical indicia. The front end has a front end connector with a second gender type. The rear end has a rear end connector with a second gender type.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 depicts a perspective view of a set of blocks according to an aspect of the invention (with a beginning block, a middle block, an ending block, a spacer block, and another beginning block);

FIG. 2 depicts a reverse perspective view of the set of blocks of FIG. 1;

FIG. 3 depicts a perspective view of the set of blocks of FIG. 1 with the blocks sequentially attached to each other; and

FIG. 4 is a plan view of the set of blocks of FIG. 1 (with various connectors of the various blocks indicated in phantom lining).

Common reference numerals are used throughout the drawings and the detailed description to indicate the same elements.

### DETAILED DESCRIPTION

The detailed description set forth below in connection with the appended drawings is intended as a description of the presently preferred embodiments of the invention, and is not intended to represent the only form in which the present devices may be developed or utilized. It is to be understood, however, that the same or equivalent functions may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

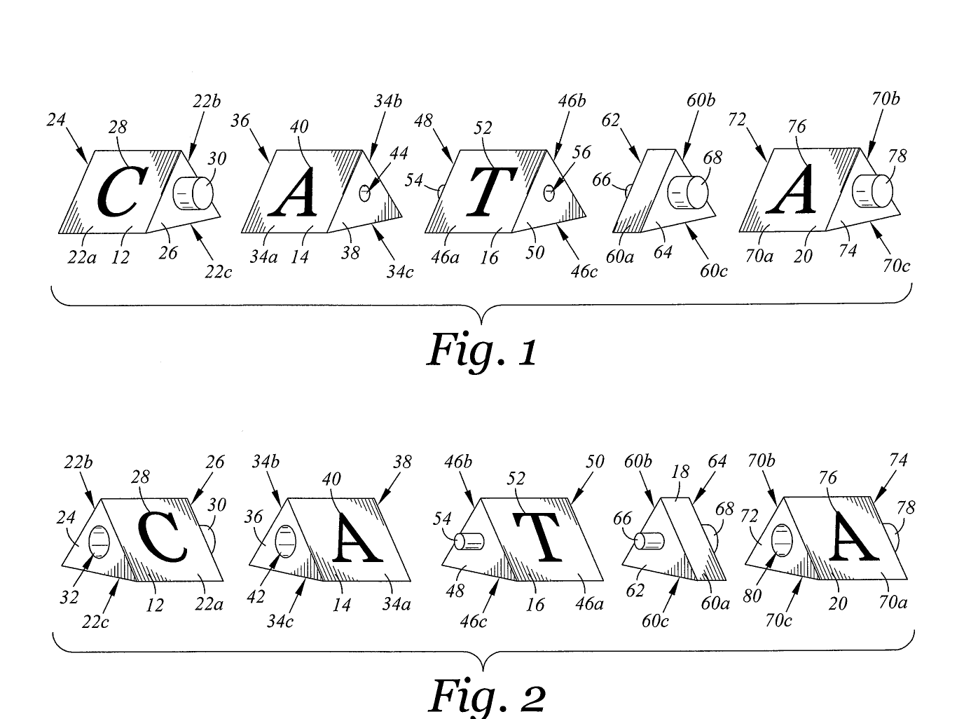

Referring now to FIG. 1 there is depicted a perspective view of a set of blocks 10 according to an aspect of the invention. There are provided a beginning block 12, a middle block 14, an ending block 16, a spacer block 18 and another beginning block 20. It is understood that the set of blocks 10 includes a plurality of beginning blocks, with beginning blocks 12 and 20 depicted as exemplary ones of other similarly configured beginning blocks. As will be discussed in further detail below, various ones of the pluralities of blocks include various different alphabetical indicia for facilitating teaching and learning. Likewise, the middle block 14, the ending block 16 and the spacer block 18 are exemplary ones of a plurality of other similarly configured blocks.

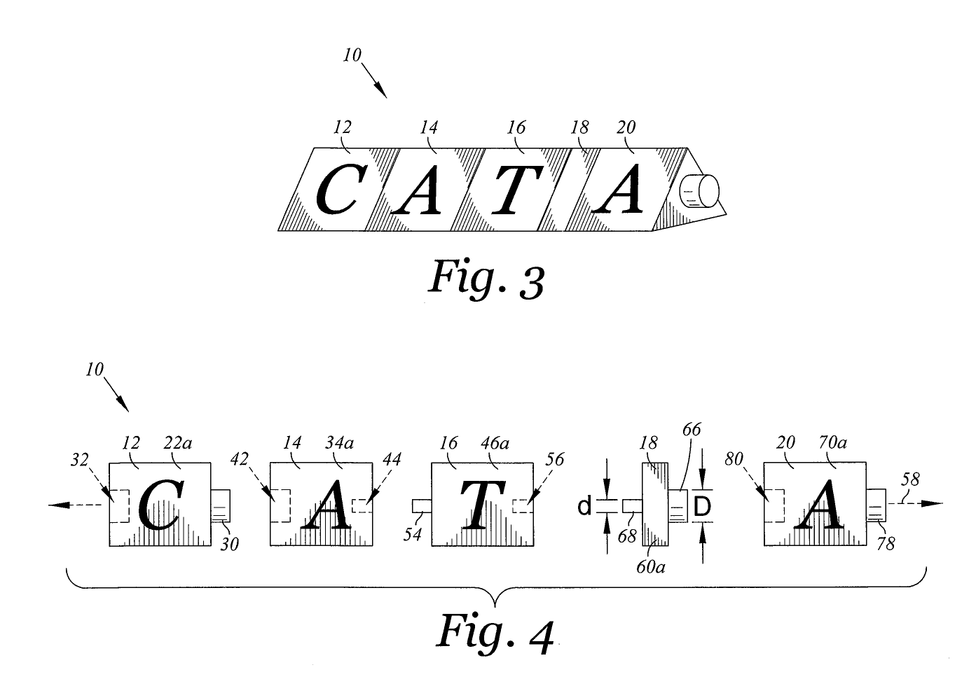

Referring additionally to FIG. 2 there is depicted a reverse perspective view of the set of blocks 10 of FIG. 1. FIG. 3 depicts a perspective view of the set of blocks 10 of FIG. 1 with the set of blocks 10 sequentially attached to each other. FIG. 4 is a plan view of the set of blocks 10 of FIG. 1 (with various connectors of the various blocks indicated in phantom lining) as align along axis 58.

According to an aspect of the invention, there is provided a set of blocks including a plurality of beginning blocks (such as beginning block 12), middle blocks (such as middle block 14) and ending blocks (such as ending block 16).

With reference to the middle block 14, the plurality of middle blocks each has at least one indicia face 34. Individual indicia faces are denoted 34a-c. The middle block 14 further includes a front end 36 and a rear end 38 disposed opposite the front end 36 with the indicia face 34a disposed between the front and rear ends 36, 38. The indicia face 34a includes alphabetical indicia 40. The front end 36 includes a first connector 42. The first connector 42 has a first gender type. The rear end 38 includes a second connector 44. The second connector 44 has a first gender type.

With reference to the beginning block 12, the plurality of beginning blocks each has at least one indicia face 22, such as indicia face 22a (individual indicia faces are denoted 22a-c). The beginning block 12 further includes a front end 24 and a rear end 26 disposed opposite the front end 24 with the indicia face 22a disposed between the front and rear ends 24, 26. The indicia face 22a includes alphabetical indicia 28. The rear end 26 includes a beginning block primary connector 30. The beginning block primary connector 30 has a second gender type opposite of the first gender type. The beginning block primary connector 30 is engageable with a first connector of a middle block (such as the first connector 42) with the indicia faces 22a, 34a of the beginning block 12 and the middle block 14 being aligned. The beginning block primary connector 30 is not engageable with a second connector of a middle block (such as the second connector 44).

With reference to the ending block 16, the plurality of ending blocks each has at least one indicia face 46, such as indicia face 46a (individual indicia faces are denoted 46a-c). The ending block 16 further a front end 48 and a rear end 50 disposed opposite the front end 48 with the indicia face 46a disposed between the front and rear ends 48, 50. The indicia face 46a includes alphabetical indicia 52. The front end 48 includes an ending block primary connector 54. The ending block primary connector 54 has a second gender type opposite of the first gender type. The ending block primary connector 54 is engageable with a second connector of a middle block (such as the second connector 44) with the indicia faces 46a, 34a of the ending block 16 and the middle block 14 being aligned. The ending block primary connector 54 is not engageable with a first connector of a middle block (such as the first connector 42).

In the embodiment depicted in the figures, the set of blocks 10 are of a triangular cross-section through each of their respective indicia faces. Each of the blocks includes a total of 5 faces or sides. It is contemplated, however, that the blocks may have other configurations with additional or less number of faces or sides. As mentioned above each of the beginning blocks 12 has at least one indicia face 22. While in this embodiment the beginning blocks 12 each has 3 indicia faces, other configurations are contemplated Likewise the middle and ending blocks 14, 16 may have other configurations with regard to the number of indicia faces 34, 46. As used herein, the term indicia face (such as indicia face 22) is one which includes alphabetical indicia (such as alphabetical indicia 28). In this regard, a given block may include other faces that do not have alphabetical indicia and may be blank or include some other form of graphic.

According to an embodiment, the front end 24 of each beginning block 12 may include a beginning block secondary connector 32 having a second gender type. In addition, the rear end 50 of each ending block 16 may include an ending block secondary connector 56 having a second gender type.

In the embodiment depicted, there is provide the additional beginning block 20. The beginning block 20 includes indicia faces 70a-c. The beginning block 20 further includes a front end 72 and a rear end 74 disposed opposite the front end 72 with the indicia face 70a disposed between the front and rear ends 72, 74. The indicia face 70a includes alphabetical indicia 76. The rear end 72 includes a beginning block primary connector 78. The beginning block primary connector 78 has a second gender type opposite of the first gender type. The front end 72 includes a beginning block secondary connector 80. The beginning block primary connector 78 is engageable with a first connector of a middle block (such as the first connector 42) with the indicia faces 70a, 34a of the beginning block 20 and the middle block 14 being aligned. The beginning block primary connector 78 is not engageable with a second connector of a middle block (such as the second connector 44). In the embodiment depicted that indicia face 70a includes the letter “A”. The use of the spacer block 18 is used to add the vowel “A” to the right of the “C”, “A” and “T” associated with the beginning, middle and ending blocks 12, 14, 16. The addition of this additional beginning block 20 allows for the formation of multi-syllable words such as “CATAPILLAR” and so forth. The additional beginning block 20 may have other letters on its other faces, such as the letter “S” to spell the word “CATS” or to be used in the spelling of “CATSUP”, for example.

The set of blocks 10 may further include a plurality of spacer blocks, such as the spacer block 18. Each of the spacer blocks, such as spacer block 18 has a blank face, such as block faces 60a-c. The spacer block 18 includes a front end 62 and a rear end 64 disposed opposite the front end 62. The blank face 60a does not include any alphabetical indicia. The front end 62 has a front end connector 66 with a second gender type. The rear end 64 has a rear end connector 68 with a second gender type. It is contemplated that the spacer blocks 20 may be used to join a beginning block to the right of an ending block so as to join syllables, word segments or words associated with the alphabetical indicia of the various blocks.

According to various embodiments, the first gender type may be female and the second gender type may be male. In this regard the beginning block primary connector 30 of the beginning block 12, the ending block primary connector 54 of the ending block 16, the front and rear end connectors 66, 68 of the spacer 18, and the beginning block primary connector 78 of the beginning block 20 are of a male gender type. The beginning block secondary connector 32 of the beginning block 12, the first and second connectors 42, 44 of the middle block 14, the ending block secondary connector 56 of the ending block 16, and the beginning block secondary connector 80 of the beginning block 20 are of a female gender type. The beginning block secondary connector 32 extends into the front end 24 in the form of a recess. Likewise, the first and second connectors 42, 44 respectively extend into the front and rear ends 36, 38, the ending block secondary connector 56 extends into the rear end 50, and the beginning block secondary connector 80 extends into the front end 72. While in this embodiment the first gender type is female and the second gender type is male, in another embodiment such gender types may be reversed.

In the embodiment depicted, the beginning block primary connector 30, the rear end connector 68, and the beginning block primary connector 78 have a cross-sectional diameter “D.” As mentioned above, the beginning block primary connector 30 is engageable with the first connector 42. As such the first connector 42 is sized to receive connectors having a cross-sectional diameter “D”. The rear end connector 68 and the beginning block primary connector 78 are also engageable with the first connector 42 of the middle block 14. The beginning block primary connector 30 is not engageable with the second connector 44 or the ending block secondary connector 56. The ending block primary connector 54 and the front end connector 68 have a cross-sectional diameter “d”. As mentioned above the ending block primary connector 54 is engageable with a second connector 44. As such the second connector 44 is sized to receive connectors having a cross-sectional diameter “d”. The ending block primary connector 54 is not engageable with the first connector 42.

This connection configuration is contemplated facilitate use of the blocks 10 that permit specific connection between the blocks 10. As will be discussed further below, this enables particular alphabetical indicia to be placed on selected ones of the pluralities of the beginning, middle and ending blocks in a logical manner to facilitate proper orthographical combinations of the blocks according to their associated alphabetical indicia.

In the embodiment depicted, the beginning block primary connector 30, the ending block primary connector 54, the front and rear end connectors 66, 68, and the beginning block primary connector 78 are of a single prong configuration with a circular cross section. Such a circular cross section facilitate axial rotation of the various blocks 12, 14, 16, 20 relative to each other to expose other faces and their associated alphabetical indicia. It is contemplated that there may be other cross sections. Rather than a constant diameter prong, other irregular shaped configurations may be utilized. Further, more than one prong may be utilized for such connection configuration. A non-circular cross-section may be used to facilitate a proper alignment with respect to faces of adjacent blocks. The relative sizing of length and diameter of the blocks may be varied as well. In the embodiment depicted, it is contemplated that the connectors are cooperatively sized and configured to snap fit or snuggly fit with each other to provide a temporary attached. At the same time, such configuration is readily removable from engagement and thus facilitates a connection that is removeably engageable.

It is contemplated that the various faces and alphabetical indicia may be coded such as by texture or color to further facilitate proper grammatical combinations of the blocks according to their associated alphabetical indicia.

According to an embodiment, the alphabetical indicia of the indicia face of a beginning block may be a consonant or consonant digraph, the alphabetical indicia of the indicia face of a middle block may be a vowel or vowel digraph, and the alphabetical indicia of the indicia faces of the beginning and the middle blocks combine to form a syllable. In the embodiment depicted for example, the alphabetical indicia 28 of the indicia face 22a of the beginning block 12 is “C”, and the alphabetical indicia 40 of the indicia face 34a of the middle block 14 is “A”. Other examples would be: M+E, H+E, and SH+E.

Consonants include: B, C, D, F, G, H, J, K, L, M, N, P, Q, R, S, T, V, W, X, Y, and Z. Consonant digraphs include: CK, FF, LL, SS, ZZ, QU, CH, SH, TH, NG, WH, and PH. Vowels include: A, E, I, O, and U. Vowel digraphs: AI, EE, IGH, OA, OI, OO, OW, AR, AIR, EAR, ER, UR, OR, URE, AY, OU, IE, EA, OY, IR, UE, AW, EW, OE, and AU.

According to an embodiment, the alphabetical indicia of the indicia face of an ending block is a consonant or consonant digraph, the alphabetical indicia of the indicia face of a middle block is a vowel or vowel digraph, the alphabetical indicia of the indicia faces of the ending and the middle blocks combine to form a syllable. In the embodiment depicted for example the alphabetical indicia 52 of the indicia face 46a of the ending block 16 is “T”, and the alphabetical indicia 40 of the indicia face 34a of the middle block 14 is “A”. Other examples would be: A+N, A+M, A+SH, A+SK.

According to an embodiment, the alphabetical indicia of the indicia face of a beginning block is a consonant or consonant digraph, the alphabetical indicia of the indicia face of a middle block is a vowel or vowel digraph, and the indicia face of an ending block is a consonant or consonant digraph. The alphabetical indicia of the indicia faces of the beginning, the middle and the ending blocks combine to form a syllable. In the embodiment depicted for example the alphabetical indicia 28 of the indicia face 22a of the beginning block 12 is “C”, the alphabetical indicia 40 of the indicia face 34a of the middle block 14 is “A”, and the alphabetical indicia 52 of the indicia face 46a of the ending block 16 is “T”. Other examples would be: D+O+G, CH+UR+CH, D+EE+P, and SH+O+P.

According to an embodiment, the alphabetical indicia of the indicia face of a beginning block is a consonant or consonant digraph, the alphabetical indicia of the indicia face of a middle block is a vowel, the alphabetical indicia face of an ending block is a consonant, and the alphabetical indicia of another ending block is a grapheme ‘e’, the alphabetical indicia of the indicia faces of the beginning, the middle and the ending blocks combine to form a syllable containing a split digraph. Examples would be: D+A+T+E, R+A+T+E, C+A+P+E, and R+O+P+E. Split digraphs include: A-E, E-E, I-E, O-E, and U-E.

According to an embodiment, the alphabetical indicia of the indicia face of a beginning block is an onset and the alphabetical indicia of the indicia face of a middle block is a rime, the alphabetical indicia of the indicia faces of the beginning and the middle blocks combine to form a word. Examples would be: C+AT, D+OG, P+ACK, and P+INK.

Onsets include: B, C, D, F, G, H, J, K, L, M, N, P, R, S, T, V, W, Y, Z, CH, SH, TH, WH, PH, TR, DR, GR, CR, BR, FR, BL, FL, GL, PL, CL, SL, SP, ST, TW, SM, SCR, SHR, STR, and THR. Rimes include: ACK, AW, INK, AIN, AY, IP, AKE, EAT, IT, ALE, ELL, OCK, ALL, EST, OKE, AME, ICE, OLD, AN, ICK, OP, ANK, IDE, OR, EAP, IGHT, OT, ASH, ILL, UCK, AT, IN, UG, ATE, ING, UMP, and UNK.

According to an embodiment, the alphabetical indicia of the indicia face of a beginning block is a prefix and the alphabetical indicia of the indicia face of a middle block is a root word, the alphabetical indicia of the indicia faces of the beginning and the middle blocks combine to form a word. Examples would be AUTO+GRAPH and DE+SIGN.

Prefixes include: AD, AMPHI, AN, AUTO, CO, DE, DIS, FOR, IL, IM, IN, IR, MAL, PRO, RE, SUB, TRANS, and UN. Roots include: ACT, AUD, CRED, DIC, GRAPH, LOC, MAN, MOT, PED, POP, PORT, SIGN, SPEC, TRACT, VID, and VOLVE.

According to an embodiment, the alphabetical indicia of the indicia face of an ending block is a suffix and the alphabetical indicia of the indicia face of a middle block is a root word, the alphabetical indicia of the indicia faces of the middle and the ending blocks combine to form a word. Examples would be MAN+AGE and ACT+OR.

Suffixes include: ADE, AGE, ANT, CLE, DOM, ENT, FUL, IC, LESS, LET, LY, MENT, and OR.

According to an embodiment, the alphabetical indicia of the indicia face of a beginning block is a prefix, the alphabetical indicia of the indicia face of a middle block is a root word, and the alphabetical indicia of the indicia face of an ending block is a suffix, the alphabetical indicia of the indicia faces of the beginning, the middle and the ending blocks combine to form a word. Example would be MIS+MAN+AGE and DE+SIGN+ER.

The particulars shown herein are by way of example and for purposes of illustrative discussion of the embodiments of the present invention only and are presented in the cause of providing what is believed to be the most useful and readily understood description of the principles and conceptual aspects. In this regard, no attempt is made to show more details than is necessary for a fundamental understanding of the disclosure, the description taken with the drawings making apparent to those skilled in the art how the several forms of the presently disclosed invention may be embodied in practice.

What is claimed is:

1. A set of blocks comprising:
a plurality of middle blocks each having an indicia face, a front end and a rear end disposed opposite the front end with the indicia face disposed between the front and rear ends, the indicia face including alphabetical indicia, the front end including a first connector, the first connector having a first gender type, the rear end including a second connector, the second connector having a first gender type;
a plurality of beginning blocks each having an indicia face, a front end and a rear end disposed opposite the front end with the indicia face disposed between the front and rear ends, the indicia face including alphabetical indicia, the rear end including a beginning block primary connector, the beginning block primary connector having a second gender type opposite of the first gender type, the beginning block primary connector being engageable with a first connector of a middle block with the indicia faces of the beginning block and the middle block being aligned, the beginning block primary connector not being engageable with a second connector of a middle block; and
a plurality of ending blocks each having an indicia face, a front end and a rear end disposed opposite the front end with the indicia face disposed between the front and rear ends, the indicia face including alphabetical indicia, the front end including an ending block primary connector, the ending block primary connector having a second gender type opposite of the first gender type, the ending block primary connector being engageable with a second connector of a middle block with the indicia faces of the ending block and the middle block being aligned, the ending block primary connector not being engageable with a first connector of a middle block.

2. The set of blocks of claim 1 wherein the first gender type is female and the second gender type is male.

3. The set of blocks of claim 1 wherein the first and second connectors of the middle blocks have differing cross-sectional configurations.

4. The set of blocks of claim 1 wherein the first and second connectors of the middle blocks have a circular cross section.

5. The set of blocks of claim 1 wherein the beginning blocks, the middle blocks, and the ending blocks each have a triangular cross-section through the indicia faces.

6. The set of blocks of claim 1 wherein the front end of each beginning block includes a beginning block secondary connector, the beginning block secondary connector has a second gender type.

7. The set of blocks of claim 1 wherein the rear end of each ending block includes an ending block secondary connector, the ending block secondary connector has a second gender type.

8. The set of blocks of claim 1 wherein the alphabetical indicia of the indicia face of a beginning block is a consonant or consonant digraph, the alphabetical indicia of the indicia face of a middle block is a vowel or vowel digraph, the alphabetical indicia of the indicia faces of the beginning and the middle blocks combine to form a syllable.

9. The set of blocks of claim 1 wherein the alphabetical indicia of the indicia face of an ending block is a consonant or consonant digraph, the alphabetical indicia of the indicia face of a middle block is a vowel or vowel digraph, the alphabetical indicia of the indicia faces of the ending and the middle blocks combine to form a syllable.

10. The set of blocks of claim 1 wherein the alphabetical indicia of the indicia face of a beginning block is a consonant or consonant digraph, the alphabetical indicia of the indicia face of a middle block is a vowel or vowel digraph, the alphabetical indicia of the indicia face of an ending block is a consonant or consonant digraph, the alphabetical indicia of the indicia faces of the beginning, the middle and the ending blocks combine to form a syllable.

11. The set of blocks of claim 1 wherein the alphabetical indicia of the indicia face of a beginning block is a consonant or consonant digraph, the alphabetical indicia of the indicia face of a middle block is a vowel, the alphabetical indicia face of an ending block is a consonant, and the alphabetical indicia of another ending block is a grapheme ‘e’, the alphabetical indicia of the indicia faces of the beginning, the middle and the ending blocks combine to form a syllable containing a split digraph.

12. The set of blocks of claim 1 wherein the alphabetical indicia of the indicia face of a beginning block is an onset and the alphabetical indicia of the indicia face of a middle block is a rime, the alphabetical indicia of the indicia faces of the beginning and the middle blocks combine to form a word.

13. The set of blocks of claim 1 wherein the alphabetical indicia of the indicia face of a beginning block is a prefix and the alphabetical indicia of the indicia face of a middle block is a root word, the alphabetical indicia of the indicia faces of the beginning and the middle blocks combine to form a word.

14. The set of blocks of claim 1 wherein the alphabetical indicia of the indicia face of an ending block is a suffix and the alphabetical indicia of the indicia face of a middle block is a root word, the alphabetical indicia of the indicia faces of the middle and the ending blocks combine to form a word.

15. The set of blocks of claim 1 wherein the alphabetical indicia of the indicia face of a beginning block is a prefix, the alphabetical indicia of the indicia face of a middle block is a root word, and the alphabetical indicia of the indicia face of an ending block is a suffix, the alphabetical indicia of the indicia faces of the beginning, the middle and the ending blocks combine to form a word.

16. The set of blocks of claim 1 further include a plurality of spacer blocks, each of the spacer blocks has a blank face, a front end and a rear end disposed opposite the front end, the blank face does not include any alphabetical indicia, the front end has a front end connector, the front end connector has a second gender type, the rear end has a rear end connector, the rear end connector has a second gender type.
